(19) United States
(12) Patent Application Publication
(10) Pub. No.: US 2015/0348019 A1
(43) Pub. Date: Dec. 3, 2015

(54) Image Analysis for Account Authorization

(71) Applicant: Visa International Service Association, San Francisco, CA (US)

(72) Inventors: Patrick Faith, Foster City, CA (US); Theodore Harris, Foster City, CA (US); Matthew Quinlan, Foster City, CA (US); Nick Giannaris, Foster City, CA (US); Phaneendra Gullapalli, Foster City, CA (US); Justin Bartee, Foster City, CA (US); Scott Edington, Foster City, CA (US)

(21) Appl. No.: 14/726,499

(22) Filed: May 30, 2015

Related U.S. Application Data
(63) Continuation of application No. 62/005,448, filed on May 30, 2014.

(51) Int. Cl. G06Q 20/38; G06Q 20/40

(52) U.S. Cl. CPC G06Q 20/382; G06Q 20/405

(57) ABSTRACT

Payment devices have physical characteristics and these physical characteristic may change in predictable ways. Further, backgrounds may also have physical characteristics which may change in predictable ways. By examining digital images for physical characteristics, some of which cannot even be seen, a better decision on whether a transaction is fraudulent may be made.

### PRIORITY

This application is a continuation of U.S. provisional patent application No. 62/005,448 filed May 30, 2014.

### BACKGROUND

Online commerce has developed into a mainstream alternative to conventional in-store retail shopping and has also created opportunities for new online service offerings. It is now common for a consumer to browse online product and service offerings, select, order, and pay for a product and/or a service in a financial transaction that is substantially all online. However, online transactions may be vulnerable to security breaches and various forms of fraud.

In particular, one of the problems with a typical online credit card verification process is that it circumvents the customary signature and identification verification protocols that take place during an in-store retail transaction. For example, during a typical online transaction, a merchant provides an order form that requires a consumer to enter personal data such a name, a billing address, a telephone number, and credit card information. The consumer enters and sends the data requested in the form over the internet or some other data connection. The merchant verifies that the credit card information is valid and that the card may be charged the payment amount. The card verification is usually conducted over a proprietary billing center verification network, such as the VisaNet network. However, the personal data and the credit card information provided by the consumer may have been acquired illicitly. Neither the merchant nor the billing center is able to reliably verify that the individual providing the personal data and credit card information is the true authorized user of the credit card. Additionally, neither the merchant nor the billing center is able to reliably verify that the individual providing the credit card details has physical possession of the actual credit card, or assess whether such a card is authentic or a counterfeit.

By contrast, during an in-store transaction, a sales clerk may request signed photo identification in order to verify that the person tendering the credit card is the true authorized user of the credit card. The sales clerk may then compare the signatures on the credit card and the sales slip against the signature on the picture identification, and also verify that the consumer is the same person shown on the picture identification. Moreover, the possibility that picture identification may be requested serves as a potential deterrent against using an illicitly acquired payment instrument during an in-store transaction. In some cases, sales personnel learn to recognize the names and faces of frequent customers. Additionally, given the nature of the transaction, the sales clerk may visually and physically inspect the credit card offered to assess whether or not the card is authentic or a counterfeit.

### SUMMARY

A process of examining a digital image or images of a payment device or payment device background to assist in determining whether a transaction is fraudulent is disclosed. Payment devices have physical characteristics and these physical characteristic may change in predictable ways. Further, backgrounds may also have physical characteristics which may change in predictable ways. By examining digital images for physical characteristics, some of which cannot even be seen, a better decision on whether a transaction is fraudulent may be made.

The process may have a variety of steps or blocks which may occur in or out or order. Video data may be received including a representation of a payment instrument and a background. One or more payment instrument characteristics may be identified from the received video data and one or more background characteristics may be identified from the received video data. One or more of the identified payment instrument characteristics may be compared to corresponding fraudulent payment instrument characteristics to calculate an assessment score. In addition, one or more of the identified background characteristics may be compared to corresponding fraudulent background characteristics to further calculate the assessment score. The assessment score may be reviewed to determine whether it satisfies a validity threshold and an authorization indicator, which may be positive or negative, may be provided in response to the determination.

### BRIEF DESCRIPTION OF THE DRAWINGS

FIG. 1 is an illustration of a process of reviewing an image for fraud;

FIG. 2 is an illustration of the elements of the system;

FIG. 2A1 is an illustration of a payment device and a background;

FIG. 2A2 is an illustration of a payment device and a background with more wear markings;

FIG. 2A3 is an illustration of a payment device and a background with additional wear markings;

FIG. 2A depicts a cross section view of a portable consumer background;

FIGS. 2B and 2C depict a cross section view of a portable consumer background;

FIG. 3 illustrates a top layer view of a layer of conductors according to an embodiment of the present invention;

FIG. 4 depicts the process and result of creating fissure patterns in a portable consume device according to an embodiment of the device;

FIG. 5A depicts a fissure pattern;

FIG. 5B depicts a cross section of a fissure;

FIG. 6 depicts a system for creating fissures; and

FIG. 7 depicts a system for analyzing transactions.

### SPECIFICATION

At a high level, the disclosed system may receive an image of a payment card and a background and review the image to determine if the image has any signs that the transaction should not be authorized. The image may be reviewed for card related data such as an account number, an expiration date, a CCV code, and account name, an issuing bank, etc. The image may also be reviewed for data that relates more to the physical condition of the payment instrument and the physical environment in which the image was taken.

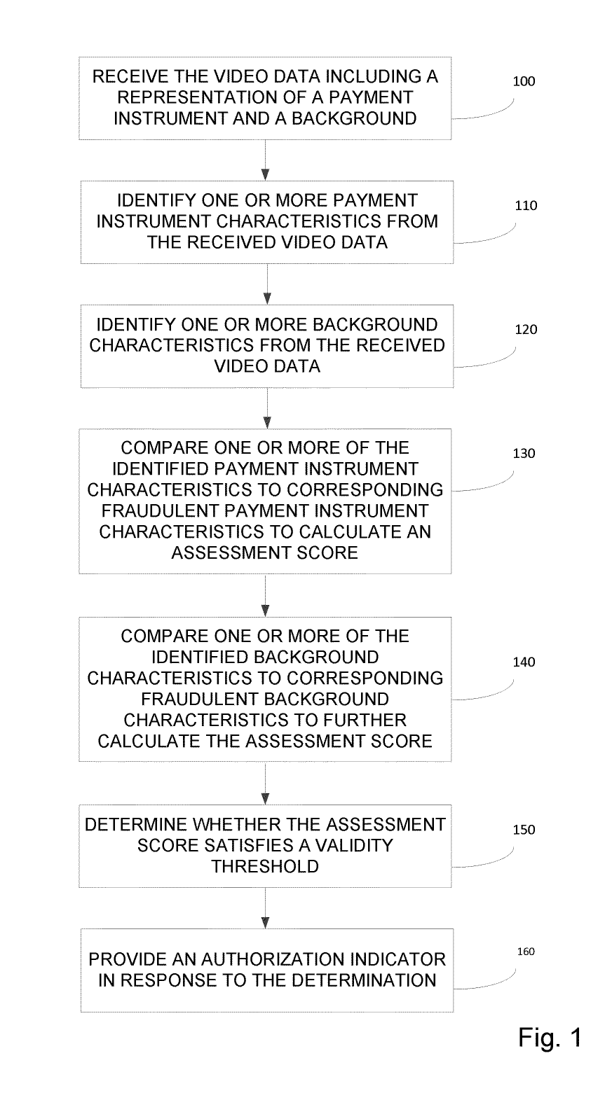

FIG. 1 may illustrate a computer-implemented process of verifying an online financial transaction using video data. The process may have a variety of steps or blocks which may occur in or out or order. The process may be one or more computer programs or applications and may use one or more processors. A memory may store one or more programs for execution by the one or more processors which may operate across a network or a cloud of computers working in concert to appear as a single device to a user.

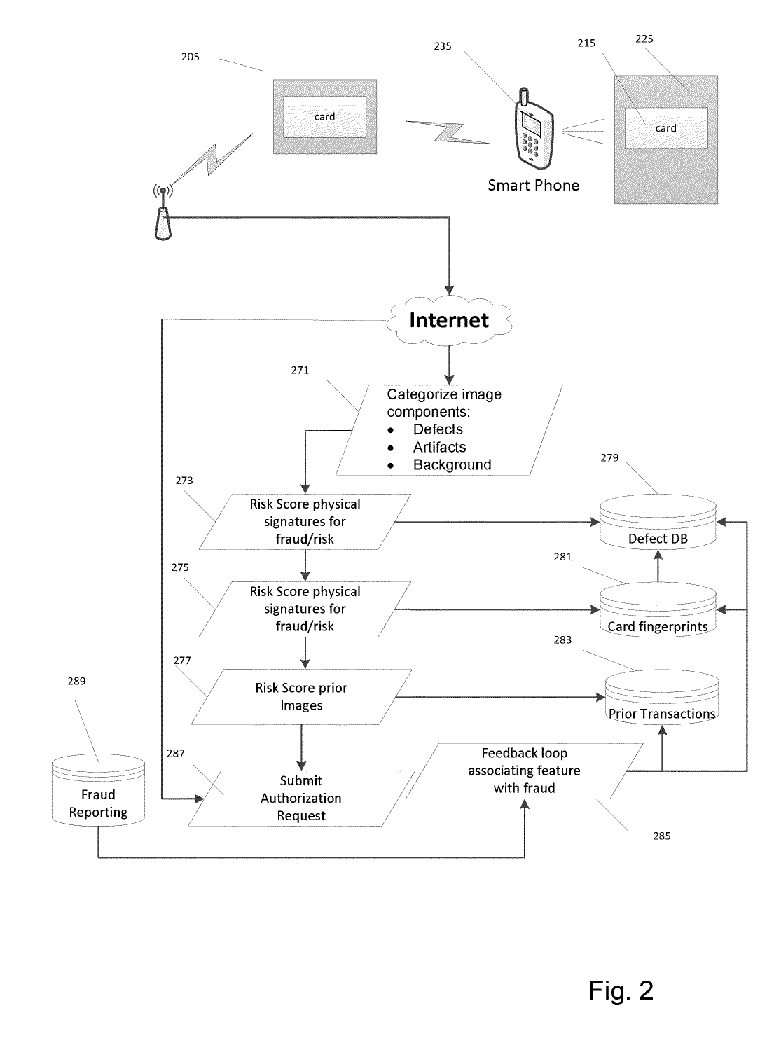

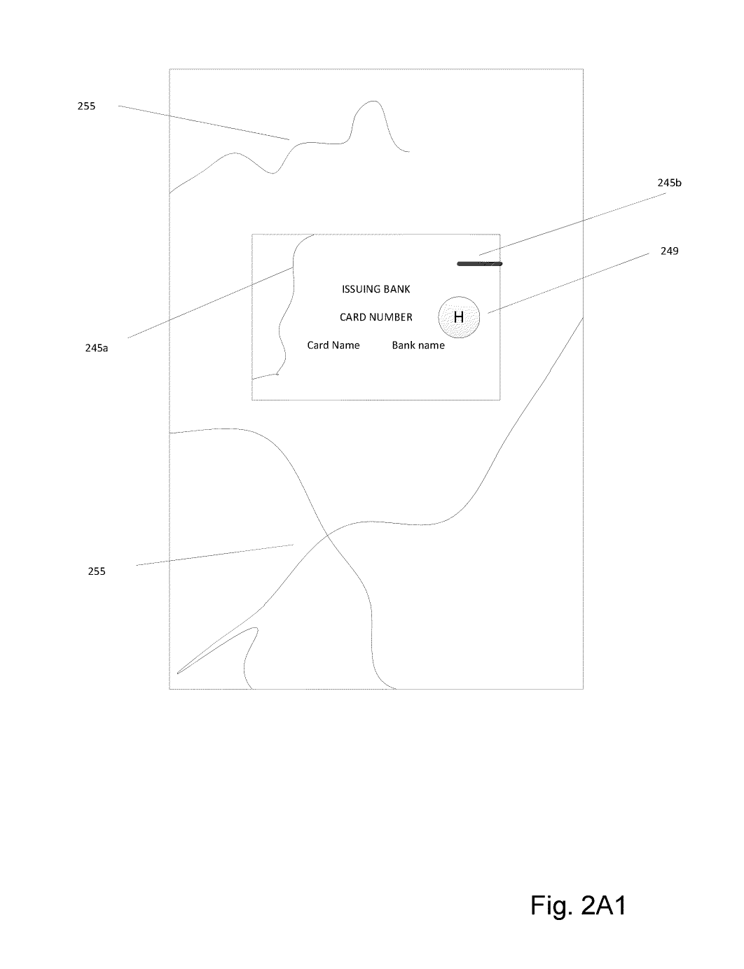

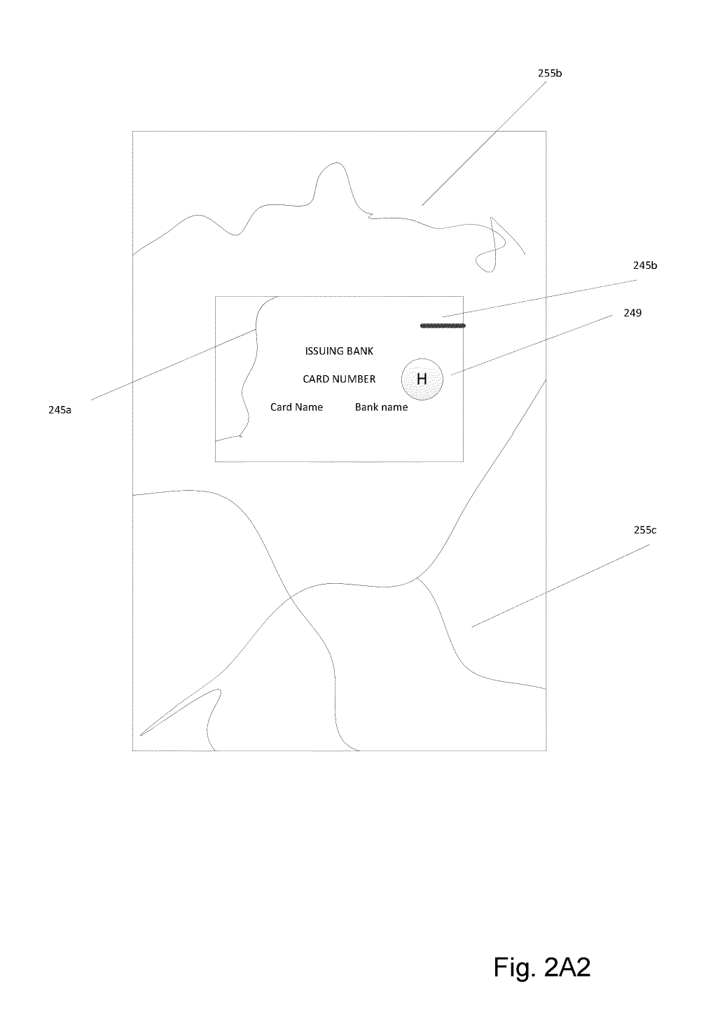

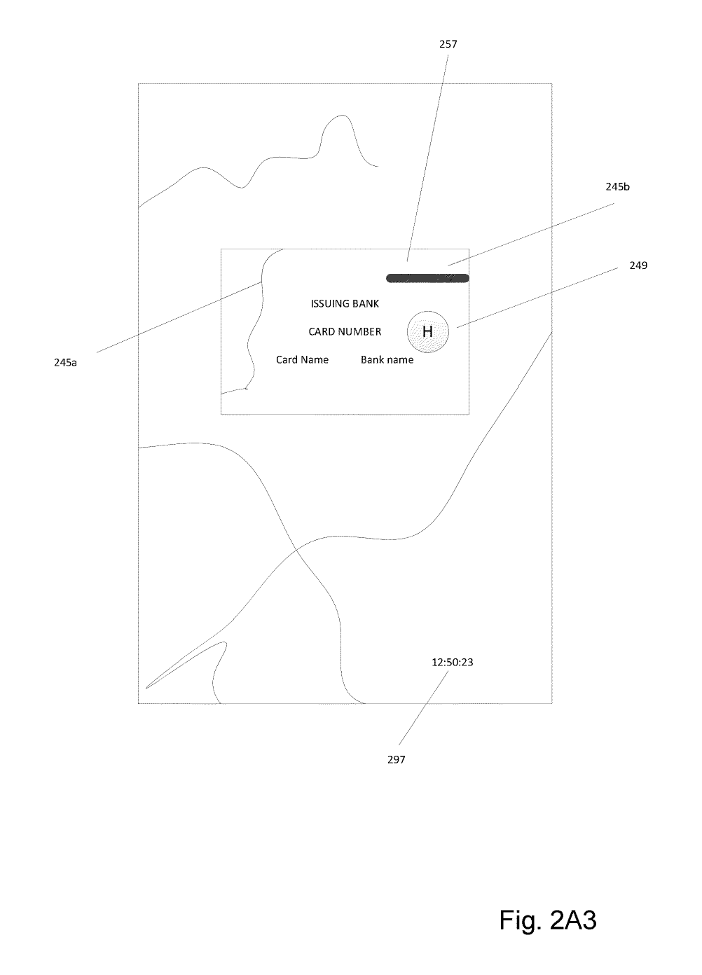

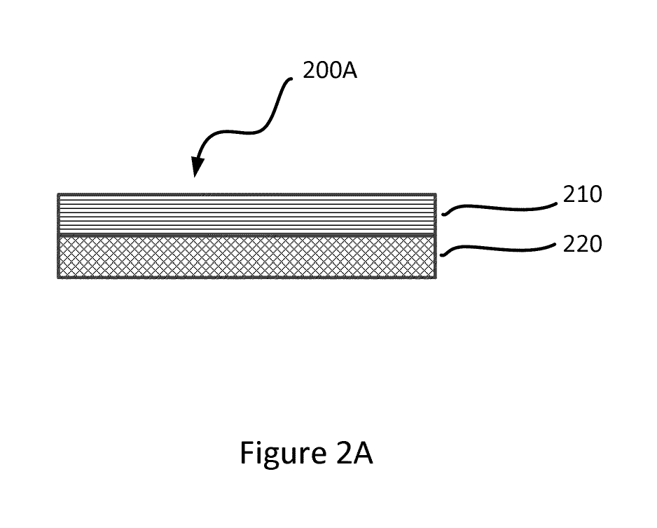

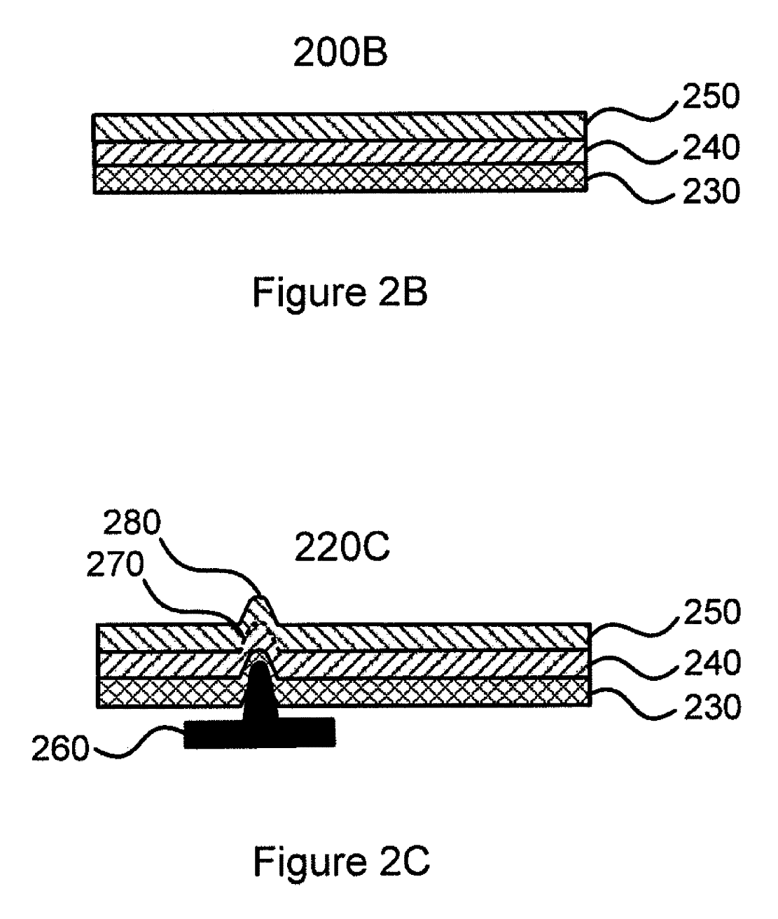

At block 100, video data 205 for a transaction may be received. The video data 205 (FIG. 2) may including a representation of a physical payment instrument 215 and a background 225. The video data 205 may be created by a digital camera 235 or other device that may create digital images. As an example, most smart phones have cameras 235 and may be able to create sufficient images to be the video data 205. In other embodiments, a point of sale may have a digital camera 235 that is designed to take photos of payment devices 215 and backgrounds 225.

The video data 205 may include a plurality of views, such as a front and a back of a payment instrument 215 or the side or width of the payment instrument 215. By having multiple views, the video data will provide a more complete view of the payment device 215 and the background 225. As an example, light sources may be used to create shadows which may be more easily noticed in a series of pictures that in a single image.

Logically, the payment information on the payment instrument 215 may be obtained by subjecting the image 205 to an optical character recognition routine. The determined characters may be cross-checked among the plurality of views of the image 205. Some sample data on the payment device 215 may include at least one of a card verification value (CVV), card number, an expiration date, an issuing bank and a user name.

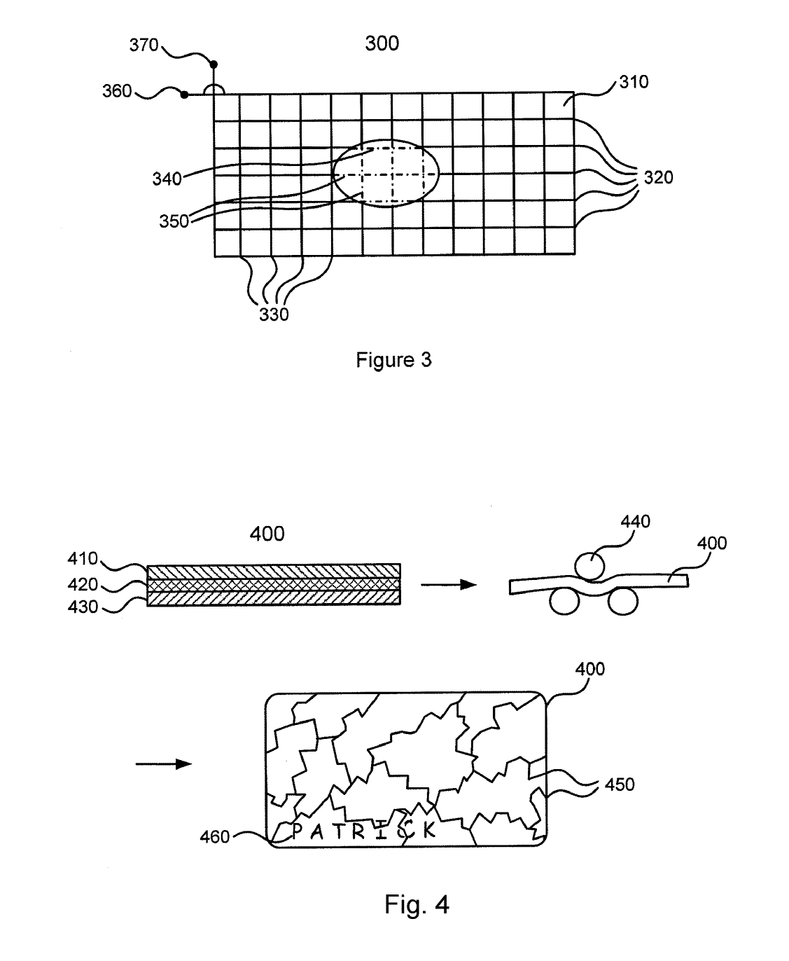

At block 110, one or more payment instrument 215 characteristics may be identified from the received video data 235. As illustrated in FIG. 3, the payment instrument characteristics 245 may be many and varied. As an example and not limitation, the payment instrument 215 may have a crack as a physical characteristic 245a. It may also have a wear mark 245b. Logically, these physical characteristics 245 may continue to expand over time such as 225b or 253 as illustrated in FIGS. 2A2 and 2A3. In addition, new cracks may appear 255a (FIG. 2A2). Similarly, the physical characteristics 245 may not recede over time and the progression of wear and cracks may be tracked to ensure that an anomaly is not present which would indicate risk or fraud.

Other, less obvious physical characteristics may be reviewed to ensure fraud is not occurring. In one embodiment, the video data 205 may be reviewed for a reflection in a hologram on the payment instrument 215. If the user is facing the card, the user may be visible in the hologram. In other instances, the camera 235 may be visible in the hologram and the camera may be compared to previous cameras used to create digital images 205.

As yet another example, the color on protruding characters on the payment device 215 may gradually wear off over time. Thus, the color on the protruding characters may be examined for indications of wear. Similarly, the color on the payment device 215 may be engineered to fade over time and the color of the payment device 215 may be analyzed as the color should logically fade.

Similarly, at block 120, one or more background characteristics 255 may be identified from the received video data 205. Background characteristics may take on a variety of forms. In some embodiments, the background may be a user's hand and the hand may be analyzed for characteristics unique to the user. Some unique characteristics may include fingerprints, vein location, hair length, lines on a hand, etc.

The background also may be of a substance that degrades over time. For example, plastics may be created that yellow over a period of time. Similarly, plastics may harden and crack over a period of time. Both of these scenarios would allow the relative time of a photo to be identified based on the crack progression or the color degradation. In addition, the color and crack pattern may be unique and may allow transactions on a known background to be traced.

FIG. 2A depicts the cross section of a portable consumer background according to one embodiment of the present invention. Portable consumer background 200A includes two layers. In various embodiments, layer 210 is a substrate layer and may be made up of any suitable material including, but not limited to, plastic, resin, metal, or some combination or composite thereof. For many embodiments, it is desirable to choose a material for substrate 210 that balances the rigidity of the material with the ability of the material to be stamped or embossed, such as when embossed with account numbers, names and other information. Such embossed features may be achieved by custom or standardized stamps, presses, impact printers, molds or otherwise. In various embodiments, it is desirable for the substrate to not puncture or perforate when stamped or embossed.

In some embodiments, layer 220, in contrast to layer 210, is a brittle material that may break, crack, crease or otherwise become discontinuous when subjected to shearing, stress or strain. In various other embodiments, brittle material layer 220 is stable enough that once it is intentionally broken or cracked to create a unique fissure pattern during the manufacturing or issuing process, further cracking and breakage stops or is minimal. In some embodiments, brittle material layer 220 may be heat treated, irradiated, chemically set or otherwise annealed or softened to prevent further breakage after the initial intentional cracking. In some embodiments, brittle material layer 220 is resistant to surface scratches and abrasions.

In various embodiments, brittle material layer is opaque to specific bands of the electromagnetic spectrum. For example, in one embodiment, brittle material layer 220 is opaque to ultra violet light. In yet another embodiment, brittle material layer 220 is opaque to infrared light. When brittle material layer 220 is opaque, the fissure pattern may be detected or imaged by back illuminating the portable consumer background 200A and imaging or otherwise detecting the resulting illuminated fissure pattern. In various embodiments of the present invention, substrate layer 210 is at least partially translucent to whatever band or frequency of the electromagnetic spectrum to which brittle material layer 220 is opaque.

FIG. 2B depicts portable consumer background 200B according to various embodiments of the present invention. Portable consumer background 200B is similar to the portable consumer background 200A in FIG. 2A, except portable consumer background 200B includes three layers; 230, 240 and 250. In various embodiments, layer 230 is a substrate layer similar to layer 210 described above and may be made of material including, but not limited to, plastic, metal, resin, or an appropriate polymer that may be formulated to have the desired balance of rigidity and malleability. In various embodiments, the balance of rigidity and malleability is achieved when layer 230 may withstand stamping, embossing or bending without breaking, splitting or perforating. Layer 240 is a brittle material that may include, but is not limited to, glass, ceramic or doped silicon.

In various embodiments, brittle material layer 240 may be annealed or softened to prevent breakage once a fissure pattern is produced in the portable consumer background 200B. The brittle material layer 240 may be made hard enough or soft enough so that after the intentional cracking it resists or prevents further cracking. In various embodiments, fissures patterns are produced in brittle material layer 240. Brittle material layer 240 is then annealed or softened before protective layer 250 is applied to portable consumer background 200B. In other embodiments, protective layer 250 is applied to portable consumer background 200B and then brittle material layer 240 is annealed. In yet other embodiments, layers 230, 240 and 250 are joined together and then the fissure pattern is created in portable consumer background 200B. Once the fissure pattern is created in the portable consumer background 200B, the entire portable consumer background 200B is treated such that substrate layer becomes more rigid to protect brittle material layer 240, brittle material layer 240 is annealed, and protective layer 250 is fused to brittle material layer 240 and hardened to prevent further breaking or movement of brittle material layer 240.

In various embodiments, protective layer 250 may conceal at least some of the area of the brittle material layer 240 from view. In various other embodiments, protective layer 250 can be at least partially translucent (e.g. transparent). In yet other embodiments, protective layer 250 is translucent in some regions of the portable consumer background 200B and opaque over other regions of the portable consumer background 200B. In such embodiments, it is possible to see the portions of the fissure patterns in the regions where protective layer 250 is translucent, whereas the portions of the fissure pattern under concealed regions of the protective layer 250 are hidden from view. In some embodiments, protective layer 250 may be opaque to visible light but translucent or transparent to other bands or frequencies of the electromagnetic spectrum outside of the human visible spectrum.

FIG. 2C depicts one process of creating a fissure pattern in the brittle material layer 240 according to various embodiments of the present invention. In various embodiments, protective layer 250, brittle material layer 240 and substrate layer 230 are stacked as shown in portable consumer background 200C. In some embodiments, the process starts with forming and cutting a precursor for the substrate layer 230 into the desired size, shape and thickness. In some embodiments, the substrate layer 230 has the same lateral dimensions as the other layers. In various embodiments, the substrate layer 230 is approximately 0.5 mm to 2 mm thick. In such embodiments, the overall thickness of the portable consumer background, including the substrate layer 230, the brittle material layer 240 and the protective layer 250 should be in the range between 0.6 mm to 2.5 mm.

In various embodiments, brittle material layer 240 is applied to the substrate layer 230. Application of the brittle material layer 240 to substrate layer 230 may be achieved in numerous ways. In one embodiment, brittle material layer 240 is a sheet of material that may be adhered to the surface of substrate layer 230 (e.g. in a lamination processes). In various embodiments, brittle material layer 240 is applied as a paint, liquid, gel or slurry. In such embodiments, the brittle material layer may be brushed, rolled or sprayed onto the surface of substrate layer 230. In various embodiments, the paint, liquid, gel or slurry for the brittle material is dried, treated or otherwise hardened before proceeding to the next step. In various embodiments, the drying of brittle material layer 240 causes fissure patterns in brittle material layer 240. For example, a paint or a slurry of a solvent and a pigment may be formulated to result in an unpredictable cracked pattern similar to that observed in quickly dried mud or paint or crazed glass. Those skilled in the art will recognize that there are various processes that may be used to create unpredictable and random fissure patterns in the brittle material layer without departing from the spirit or scope of the present invention.

In various embodiments, protective layer 250 is applied to the exposed surface of brittle material layer 240. In some embodiments, protective layer 250 is a film and is applied in sheet form. In various other embodiments, protective layer 250 is applied as a paint, liquid, gel or a slurry. In various embodiments, at least a portion of the protective layer 250 is opaque to visible light. In other embodiments, protective layer 250 is transparent to visible light over all or some of the area of the portable consumer background 200C. In this way, the surface of brittle material layer 240 may be selectively exposed. In various embodiments it is desirable to obscure some or all of the fissure pattern to further thwart potential fraud or counterfeiting.

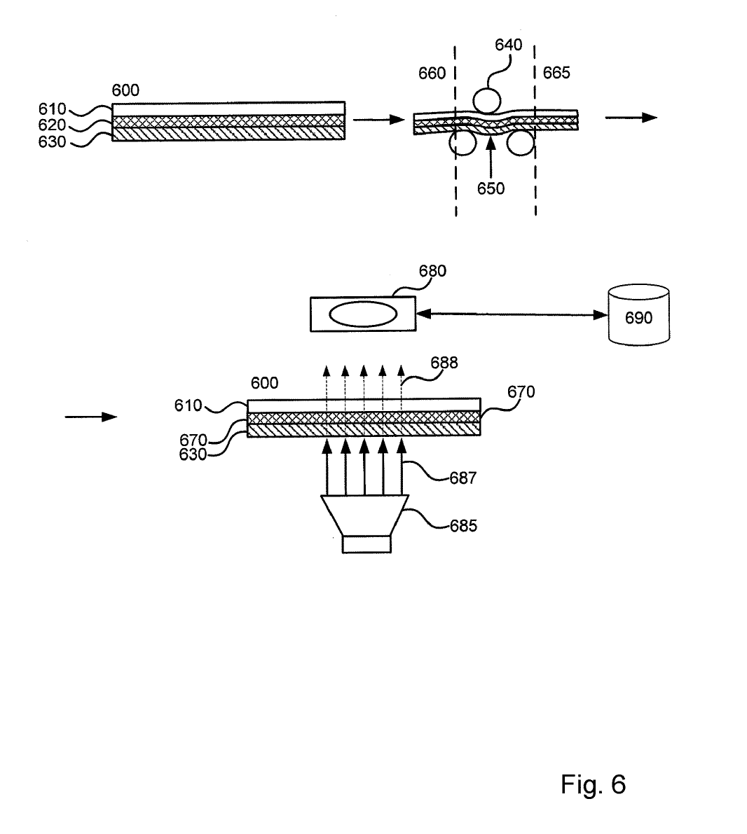

As mentioned previously, in some embodiments the brittle material layer 240 may be opaque to various forms of radiation. For example, brittle material layer may be opaque to bands of the electromagnetic spectrum in or out of the human visible range. In such embodiments, it is beneficial for the substrate layer 230, the protective layer 250 or both to be more transparent to the particular form of radiation to which the brittle material layer 240 is at least partially opaque. In various embodiments, brittle material layer 240 will polarize or reject based on polarization at least a portion of the radiation incident on portable consumer background 200B. In various embodiments, it is possible to detect the fissure patterns in brittle material layer 240 by illuminating the portable consumer background with a particular form of radiation and detecting the shadows, interference patterns, diffraction patterns, polarization effects or refraction patterns of the fissure pattern in brittle material layer 240. For example, the brittle material layer 240 may be opaque to x-rays while the protective layer 250 and the substrate layer 230 are transparent to x-rays. In this way, an x-ray image of the fissure pattern may be produced with an x-ray emitter and an x-ray detector. Such a process is described in more detail in reference to FIG. 6.

In various embodiments of the present invention, the fissure pattern is created by a stamp or embosser 260. In various embodiments, the embosser is the same one used to emboss information into the portable consumer background 200C. In various embodiments, when stamp 260 strikes or presses into the substrate layer, it pushes up and deforms substrate layer 230, which in turns cracks or breaks brittle material layer 240 and presses the cracked portion of brittle material layer 240 up and into protective layer 250. The result is an embossed figure, letter, number or symbol. In some embodiments, the fissure patterns 270 are detected or imaged on and around the regions 280 that are embossed.

FIG. 3 is an overview of a sample region 300 of brittle material layer 240 according to yet another embodiment of the present invention. Sample region 300 is lined with conductors 320 and 330 in a grid pattern. In other embodiments, conductors 320 and 330 may be in some other multi-celled configuration such as a hexagonal grid or triangular grid. In some embodiments, conductors 320 and 330 are electrically coupled. In other embodiments, conductors 320 and 330 are electrically isolated from each other. In various embodiments, the conductors are sandwiched between a substrate layer and protective layer. In various embodiments, conductors 320 and 330 are semiconductors such as doped silicon.

In various other embodiments, the conductors in one direction, such as conductors 320 are couple to a bus 390 that has a lead 370 so that an electrical signal may be applied to conductors 320. Similarly, in various embodiments, conductors 330 are coupled to bus 380 that has a lead 360 so that an electrical signal may be applied to conductors 330. In those embodiments in which conductors 320 are electrically isolated from conductors 330, a separate signal may be applied to lead 360 and lead 370. In some embodiments, the signal applied to lead 320 is different from the signal applied to lead 330.

In various embodiments, lines 350 are cracked or broken when feature 340 is embossed into sample region 300. The dimple in FIG. 3 is just an example of one type of feature 340 that may be embossed into portable consumer background 300. In various other embodiments, sample region 300 may be embossed with any information desired such as account numbers, identification information or names. Each embossed feature may create a unique fissure or breakage pattern in conductors 320 and 330 at points 350. The fissure or breakage patterns at points 350 in embossed feature 340 may be detected by appropriate means.

In various embodiments, the fissure or breakage patterns at points 350 in feature 340 may be imaged using conventional visible light imaging. In various other embodiments, fissure or breakage patterns at points 350 in feature 340 may be detected using conventional non-visible radiation imaging. For example, x-ray, ultraviolet, infrared or sound imaging may be used to detect and record fissure or breakage patterns at points 350 in feature 340. One skilled in the art will recognize that other processes of detecting fissure or breakage patterns at points 350 in feature 340 are possible without deviating from the spirit or scope of the present invention.

In various other embodiments, a signature of the electromagnetic field (EMF) may be detected to recognize the fissure or breakage patterns at points 350 in feature 340. By applying an electrical signal to leads 360, 370 or both, the array of conductors 320 and 330 will have a distinctive EMF signature that may be detected. In various other embodiments, conductors 320 and 330 are electrically coupled and the sample region may be inserted into a calibrated alternating or varied magnetic field to induce a current in each of the remaining closed loops. In such an embodiment, the current or the induced opposing magnetic field may be measured to detect the signature of the portable consumer background.

FIG. 4 is an illustration of a process to create fissure patterns in brittle material layer 420 of portable consumer background 400 according to one embodiment of the present invention. In various embodiments, portable consumer background 400 includes a substrate layer 430, a brittle material layer 420 and a protective layer 410. Portable consumer background 400 is passed through a set of rollers 440 configured to deform portable consumer background 400 to the point where brittle material layer 420 develops fissures or cracks 450. As depicted in FIG. 4, rollers 440 with offset radii are arranged so that portable consumer background 400 is deformed in a serpentine fashion as it is passed through the rollers to create fissures and cracks in brittle material layer 420. In other embodiments, fissure and cracks may be created by physical, thermal or sonic shock to the surface of portable consumer background 400.

In some embodiments, portable consumer background 400 is struck with a blunt or sharp hammer one or more times to create fissure patterns in the brittle material layer 420. In various other embodiments, the location, direction, amount of force of the blow, and hardness and shape of the hammer is varied from portable consumer background to portable consumer background to further increase the variety and style of fissure patterns created in the brittle material layer 420 of each portable consumer background manufactured.

In various embodiments, the same standardized process to create fissure patterns in the brittle material layer may be used to create a plurality of portable consumer background each with a unique fissure pattern different from the fissure pattern in any other portable consumer background produced by the standardized process. In such embodiments, the process may include a single device, or many identical devices, which subject a plurality of portable consumer background s to the same stress, strain or shock and because of the material properties of the brittle material, a fissure pattern unique to each portable consumer background will be created. The standardized process may comprise, but is not limited to, a set of rollers to deform the portable consumer background, a set of hammers or stamps with which to strike the portable consumer background, a spring loaded sudden stop or other means for applying a physical shock to the portable consumer background. In various other embodiments, the standardized process may comprise a predetermined thermal shock or sonic shock. Ideally, the nature of the material used for brittle material layer will crack, shatter or craze in unpredictable ways so that each portable consumer background produced will have a unique and irreproducible fissure pattern. One example of the desired type of fissure pattern is the unpredictable cracked, shattered or crazed patterns seen in broken or shattered sheets of glass, porcelain or ceramic. Thus, embodiments of the invention may economically use the same process to create portable consumer background including different fissure patterns that may be used to authenticate them when they are used to conduct transactions.

In some embodiments, the material used has non-crystalline or anisotropic internal structure. In other embodiments, the material used in brittle material layer 420 has crystalline or isotropic internal structure. A person of ordinary skill in the art will recognize that many types of materials may be used to make brittle material layer 420 without departing from the spirit or scope of the present background.

In various embodiments, information may be printed on brittle material layer 420 before cracks and fissures 450 are created. For example, account numbers, names and other identification information 460 may be printed on the surface of brittle material layer 420 before it is coated with protective layer 410. In such embodiments, figures and text printed on brittle material layer will break in unique ways as shown in FIG. 4 at name 460. As shown, the name “PATRICK” is broken along the “I” and the “C” at locations where the letters intersect cracks or fissures. Information regarding the location and manner in which text or figures are broken may be used, in addition to or as part of the fissure pattern data, to authenticate the portable consumer background 400.

In various embodiments, rollers 440 include three rollers where one roller is opposite the two other rollers such that portable consumer 400 device deforms in at least one direction. In various other embodiments, more than three rollers may be configured to deform portable consumer background 400 in two directions and potentially more than once by running portable consumer background 400 through rollers 440 more than once or in more than one direction. For example, portable consumer background 400 may be run through roller 440 in one direction such as along the long axis of the portable consumer background 400 and then be run through the rollers in the reverse direction. Optionally, portable consumer background 400 may then be reoriented by rotating portable consumer background 400 90.degree. around an axis perpendicular to the surface of the portable consumer background 400 and passed through rollers 440 again. One skilled in the art will recognize that the use of rollers to deform portable consumer background 400 may include many variations of orientations, number of rollers and number of passes without deviating from the spirit or scope of the present invention.

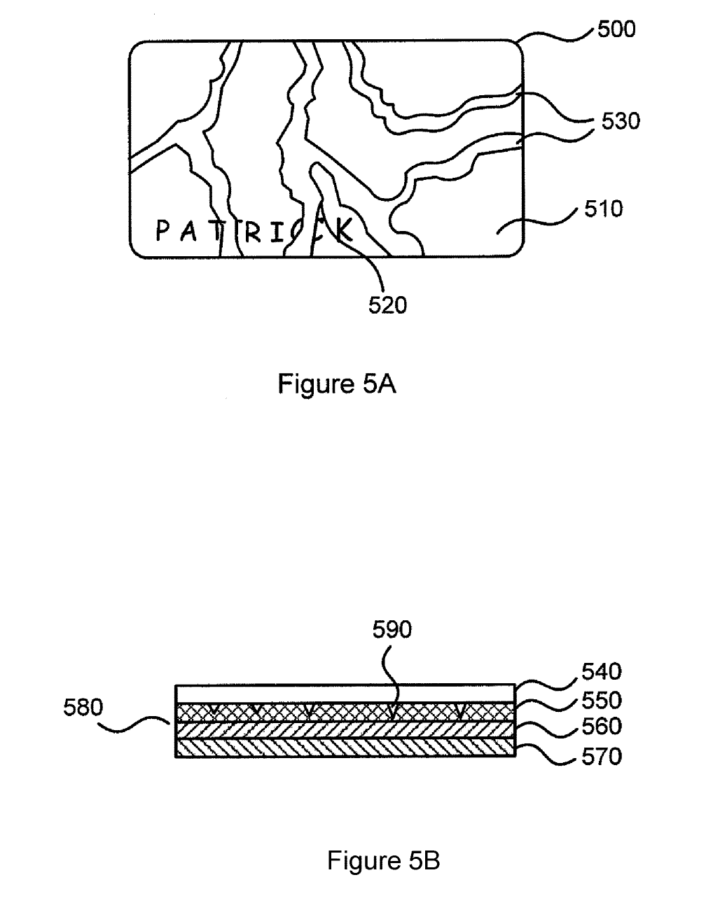

In various embodiments, fissure patterns such in FIG. 5A are created at the point of sale or issuance of each portable consumer background. Such embodiments are particularly useful to prevent fraud in consumer prepaid payment or gift cards. For example, a portable consumer background may be a prepaid gift card. In such embodiments, the fissure patterns 530 may be produced in the brittle material layer in a compact cracking device at the point of sale. For example, the gift card may be deformed to create the fissures 530 in a cracking device located near a cash register or in a kiosk. Fissure edges 520 may be especially noticeable by the fissure detection equipment and the face of the payment device may remain smooth to the touch even though the brittle material layer 420 has cracks and fissures 520.

In various embodiments of the present invention, the compact cracking device includes rollers. In various other embodiments, the compact cracking device includes a hammer surface against which or with which to strike or shock the gift card to produce fissure patterns in the brittle material layer 420. In various other embodiments, the compact cracking device includes a fissure pattern detection system that may detect and record the unique fissure pattern data of each individual portable consumer background for use later in authenticating that particular portable consumer background when a user tries to redeem it. A fissure pattern detection system is described in more detail below in reference to FIG. 6.

FIG. 5B is an illustration of a portable consumer background that uses a slurry comprising one or more solvents and one or more pigments to produce the fissure pattern in portable consumer background 500 according to one embodiment of the present invention. Portable consumer background 500 includes four layers; substrate layer 570, barrier layer 560, brittle material layer 550 and protective layer 540. In other embodiments, portable consumer background 500 may include more or fewer layers. The scale of the layers relative to one another in FIG. 5, or in any of the other figures discussed herein, should not be considered limiting in any way. One skilled in the art will recognize that various thicknesses of each layer may be used without deviating from the spirit and scope of the present invention.

In one embodiment of the present invention, substrate layer 570 and barrier layer 560 are adhered or otherwise attached to one another. In various embodiments, barrier layer 560 and substrate layer 570 may be the same layer of portable consumer background 500. In some embodiments, barrier layer 560 prevents solvents from penetrating or being absorbed by substrate layer 570. In various embodiments of the present invention, brittle material layer 550 is applied to all or some of the surface of barrier layer 560 in the form of a slurry. In various embodiments, the slurry may be used as a paint to print text, a pattern or a picture such a company name or a logo. In various other embodiments, the slurry is applied to the entire surface of barrier layer 560. The slurry may include an admixture of one or more solvents and one or more pigments. In some embodiments, the evaporation rate or concentration of each solvent used in the slurry may be different so that one solvent evaporates before the others.

In various embodiments, as the slurry dries, the top of the brittle material layer 550, because it is exposed, dries at a faster rate than the bottom of brittle material layer 550. As the solvents evaporate, the slurry dries. As the slurry dries it contracts. Because of the different rates of drying based on depth of the slurry and the types of solvents used, fissures 530 will form at the top of the slurry because the top will contract at a rate faster than the slurry closer to the barrier layer 560. In various embodiments, once the slurry is entirely dry and brittle material layer 550 includes sufficient fissure patterns 530 for use in authenticating the portable consumer background 500, brittle material layer may be treated so that more fissures do not develop after the time of manufacture.

In various embodiments, treating brittle material layer 550 may include applying plasticizers to the brittle material layer 550 to make it supple or flexible. In various other embodiments, treating brittle material layer 550 may include heating, irradiating or cooling the portable consumer background 500 to make brittle material layer softer. In various other embodiments, protective layer 540 is applied to and fused to brittle material layer to immobilize and stabilize the fissure pattern 530.

In various embodiments, brittle material layer 550 is one color and using another color, text or other figures may be printed on the surface of brittle material layer 550 while the top of the slurry is still wet. In such embodiments, the printed text or figures will crack where the top surface of the brittle material layer 550 cracks making unique cuts and breaks into the printed text or figures that may also be used for later authentication when a user presents the portable consumer background 500 to an authentication requestor.

In yet other embodiments, fissure patterns 450 and 590 may be observed or detected at the edge 580 of portable consumer background 500. In such embodiments, the edge 580 of portable consumer background 500 is presented to a sensor. By taking multiple images, the edge patterns may also be captured and analyzed as the edge patterns may be yet another unique aspect of payment devices 215 and payment backgrounds 225.

FIG. 6 is a fissure pattern producing and detection system according to one embodiment of the present invention. A portable consumer background 600 with at least a substrate layer 630, a brittle material layer 620 and protective layer 610 passes through a set of rollers 640 thus deforming portable consumer background at point 650. The deformation of portable consumer background 600 at point 650 is severe enough such that the fissure pattern in brittle material layer 620 in region 665 after the rollers is significantly different from fissure patterns that might have been present in the brittle material layer 620 in the region 660 before the rollers. Once portable consumer background 600 is processed to have a unique fissure pattern, data regarding the unique fissure patterns is detected and recorded by sensor 680. In various embodiments, source 685 directs radiation 687 at the substrate layer 630 side of portable consumer background 600 to back-expose it. Depending on whether the brittle material layer 670 is completely opaque or partially translucent to radiation 687, radiation 687 is either completely blocked or attenuated in the regions where the brittle material layer is intact. In regions where brittle material layer 670 is cracked, radiation 687 passes through portable consumer background 600 and emerges on the other side as attenuated radiation 688. In various embodiments, radiation 687 may be a form of radiation including, but not limited to, visible light, infrared light, ultraviolet light, polarized radiation, x-rays, sonic waves or sonic pulses. Attenuated radiation 688 may then be imaged or detected by sensor 680. In various embodiments, sensor 680 includes appropriate filters, receivers, polarizers or lenses to better detect attenuated radiation 688. In various embodiments, attenuated radiation 688 may be detected as a transmittance profile. In other embodiments, the attenuated radiation 688 may be measured as an integrated total transmittance value using an optical integrating device such as an integrating sphere.

In various embodiments, the fissure pattern in portable consumer background 600 is detected or imaged all at once in a single exposure like a photograph. In such embodiments, sensor 680 may be an imaging device such as a digital camera. In other embodiments, portable consumer background 600 is moved relative to sensor 680 and source 685 to display the fissure pattern. In such embodiments, sensor 680 may be a scan-head in close proximity to surface of portable consumer background 600.

In various other embodiments, brittle material layer 620 includes material that may be excited by incident radiation so as to reemit radiation. For example, brittle material layer may contain phosphors or fluorescent materials that are temporarily excited into higher energy states by electrons or ultraviolet light so that they appear to glow in all regions except where the brittle material is cracked. The resulting image of the fissure pattern looks like a dark pattern of cracks on a bright background. In such embodiments, source 685 may be mounted so that radiation 687 is incident on the portable consumer background 600 from the same side on which sensor 680 is located.

The image of fissure or other fissure data detected regarding the fissure pattern in the brittle material layer 670 may be stored in memory 690 (which may be a database). In various embodiments, fissure data may comprise data and information regarding the unique fissure pattern in the brittle material layer 670 including, but not limited to, an image of at least a portion of the fissure pattern, an EMF signature of the fissure pattern, or a transmittance profile of at least a region of the portable consumer background. Memory 690 may be local relative to sensor 680 and source 685 or it may be located at a remote location connected via a network. In yet other embodiments, the system in FIG. 6 does not include the capability to deform portable consumer background 600 such as rollers 640. In such embodiments, the system in FIG. 6 is a fissure pattern detection system that may be used to image or detect the fissure patterns in the brittle material layer 670 when a consumer presents the portable consumer background 600 to an authentication requestor for authentication. For example, a fissure pattern detection system may be included in an access device like a point-of-sale terminal.

The background 225 may be connected to a network and may display information received over the network. For example, the background 225 may be capable of displaying images received from a computing device. In this way, the background 225 may act as a type of display. A time based pattern of images may be displayed on the background 225. The timing may be known by a central authority. Similarly, most portable computing devices use a central timing signal and such timing signal may be included in images of payment device 215 and backgrounds 225. If the background image does not match the timing indicated from the image 205, then a risk score may be increased as the background image may be fake. In some embodiments such as in FIG. 2A3, the time 297 may be indicated in the background 225. If the time in the metadata of the image 205 does not closely match the time in the background 225, then a risk score may be increased and if the time matches, then a risk score may be decreased.

Referring again to FIG. 1, at block 130, one or more of the identified payment instrument characteristics may be compared to corresponding fraudulent payment instrument characteristics to calculate an assessment score. The image 205 (FIG. 2) may be filtered to allow easier OCR of the card information or to allow the defects on the card or background to be highlighted, including filtering the image to illustrate images that are not visible to the human eye. For example, the image 205 may be compressed and then expanded which may increase fidelity of the desired elements.

As illustrated in FIG. 2, the characteristics in the video data 205 may be reviewed for a variety components (271). For example, the defects on device 215, scratches on the device 215, discoloration of the device 215, chips on the device 215, and extraneous artefacts on the payment device 215 and background 225 may be reviewed (273). The defects may be stored in a defect database 279 and may be compared to past defects stored in the database. If the defects are similar to those in a past fraudulent transaction, then the risk score may be increased. If the defects are as expected considering the age and date of the device 215 and background 225, the risk score may be lowered.

Similarly, fingerprints on or around the card may be reviewed (275). The fingerprints may be stored in a fingerprints database 281 and may be compared to past fingerprints stored in the database 281. If the fingerprints are similar to those in a past fraudulent transaction, then the risk score may be increased. If the fingerprints are as expected considering the age and date of the device 215 and background 225, the risk score may be lowered.

In addition, the image data 205 may be reviewed and compared to past transaction data. The images may be stored in a prior transaction database 283 and may be compared to past transactions stored in the database 283. If the transactions are similar to those in a past fraudulent transaction such as counterfeit cards, copied transactions and stolen cards, then the risk score may be increased. If the transactions are as expected considering the age and date of the device 215 and background 225, the risk score may be lowered.

At block 140, similar to examining the payment device 215 image, one or more of the identified background characteristics 225 may be compared to corresponding fraudulent background 225 characteristics to further calculate the assessment score. The background characteristics 225 may include at least one of a surface type, an angle of photo, a lighting measurement of the payment device 205 or whether the image has been manipulated to indicate fraud. If the payment device 205 image or background 215 has previously been used in a fraudulent transaction, the risk score may be raised and the transaction may not be authorized 287 and fraud may be reported 289.

At block 150, it may be determined whether the assessment score satisfies a validity threshold and at block 160, an authorization indicator may be provided in response to the determination in block 150. Further, transactions that are deemed risky made be labeled as fraud 289.

Logically, the system may learn from past determinations and may improve over time. For example, a neural network may be used to review the past determinations that were incorrect to try to identify any signs that may be used in the future to better classify transactions as being risky or not risky. Artificial intelligence may also be used to improve the analysis as nefarious users continue to try to find new ways to commit fraud.

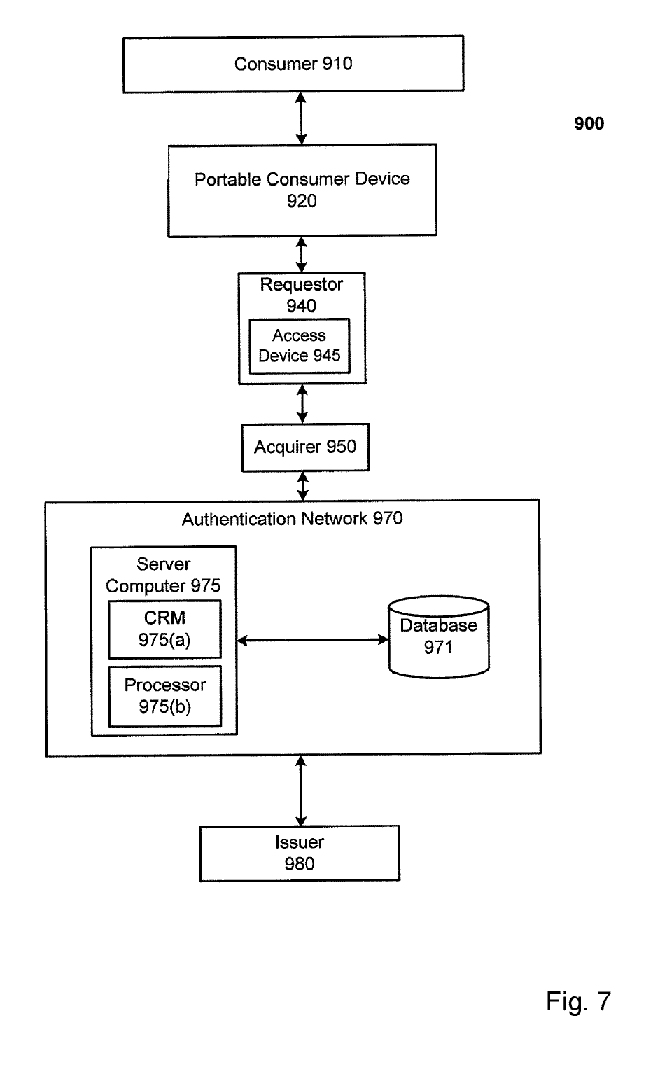

FIG. 7 is a block diagram of an exemplary system 900 according to an embodiment of the invention. Although FIG. 7 shows a number of components, the system 900 according to embodiments of the invention may comprise any suitable combination or subset of such components.

The system 900 may include a consumer 910 that uses a portable consumer background 920 having a unique fissure pattern (not shown in FIG. 7). Specific examples of portable consumer background s are provided below.

The system 900 may also include a requestor 940 associated with an access device 945 (e.g., a point-of-sale terminal or card reader). The portable consumer background 920 may communicate with the access device 945 when an authentication is conducted. The access device 945 may be configured to detect the unique fissure pattern associated with the portable consumer background 920. The system 900 also may include an acquirer 950 (e.g., a bank or security company) associated with the requestor 940.

The system 900 may also include an authentication processing network 970 having a server computer 975 in communication with a database 971. The system 900 may also include an issuer 980 that maintains an account associated with the consumer 910 and the portable consumer background 920. Some examples of issuers may be a bank, a business entity such as a retail store, a security company or a governmental entity.

The requestor 940 may be any suitable type of entity. Some examples of requestors may include a department store, a gas station, a drug store, a grocery store, a building management company, a university, etc. In practice, a request may be any entity that would like to authenticate a portable consumer background for various purposes. Some examples of contemplated purposes include payment authorization, building access or security screening, etc.

The access device 945 may be any suitable device capable of communicating with the portable consumer background 920. Examples of suitable devices include point-of-sale (POS) terminals, mobile phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, websites, and the like. Access device 945 may use any suitable contact or contactless mode of operation to communicate data to and from portable consumer background 920. In addition, access device 945 may use any suitable mode of operation to detect the fissure pattern contained in portable consumer background 920.

The payment authentication processing network 970 may include data processing subsystems, networks, and operations used to support and deliver authorization services, exception file services, and clearing and settlement services. An exemplary authentication processing network 970 may include VisaNet™. Payment processing networks such as VisaNet® are able to process credit card transactions, debit card transactions, and other types of commercial transactions. VisaNet®, in particular, includes a VIP system (Visa Integrated Payments system) which processes authorization request messages and a Base II system which performs clearing and settlement services.

In FIG. 7, the authentication processing network 970 may include a server computer 975 which is an example of a back end computer. Although FIG. 9 shows the server computer 975 residing in the payment processing network 970, it may alternatively reside at the issuer 980 in other embodiments of the invention.

A “server computer” may refer to a computer or cluster of computers. For example, the server computer 975 may be a large mainframe, a minicomputer cluster, or a group of servers functioning as a unit. In one example, the server computer 975 may be a database server coupled to a Web server (not shown). The authentication processing network 970 may use any suitable wired or wireless network, including the Internet.

As shown in FIG. 7, the server computer 975 may have a computer readable medium or computer storage medium CRM 975(a) in communication with a processor 975(b). The CRM 975(a) comprises code for performing the functions of server computer 975, while the processor 975(b) executes the code to perform the functions of server computer 975. Some examples of code stored in the CRM 975(a) include code for analyzing and comparing fissure pattern data from access device 945, code for receiving user input data from the consumer 910, code for retrieving fissure pattern data from database 971, etc. The code stored on the CRM 975(a) could also be stored on a computer readable medium residing in the portable consumer background 920, the access device 945 or a computer at the issuer 980, as any of these devices may be used to receive fissure pattern data from access device and database 971.

The authentication processing network 970 may also include a database 971 in communication with the server computer 975. The fissure pattern data from when a portable consumer background is created or activated may be temporarily or permanently stored in the database 971.

One embodiment of the present invention includes a process for using the portable consumer background 920 with a unique fissure pattern to obtain authorization for a particular transaction. According to one embodiment of the present invention, the consumer 910 may present the portable consumer background 920 to the requestor 940. The particular transaction may include many different types of transactions and the few discussed herein and should be considered exemplary and should in no way be viewed as limiting the present invention.

In various embodiments, the transaction that consumer 910 may want to engage in is a purchase for which he or she seeks authorization to make a payment for the purchase with a consumer payment account (e.g. credit or debit account) associated with the portable consumer background 920. In various other embodiments, the consumer 910 may want access to a controlled access area, such as a secure building or room, and is seeking authorization to enter based on the clearance or permission credentials associated with the portable consumer background 920. In various embodiments, the portable consumer background 920 is an access card that may be carried in the consumers 910's pocket or wallet or on a lanyard.

In some embodiments, capturing the portable consumer background 920 comprises inserting into or otherwise positioning the portable consumer background 920 on the access device 945 of the requestor 940 so the portable consumer background 920 may communicate with or the fissure pattern may be detected by the access device 945. The access device 945 may comprise components of the fissure detection system shown in FIG. 6.

After the access device 945 may receive fissure data and may send it to the to the acquirer 950, and then to the authentication network 970. The fissure data may be embedded in an authorization request message requesting authorization for the transaction. In other embodiments, the access device 945 may send the fissure data and/or the authorization request message directly to authentication network 970.

After the authentication network 970 receives the fissure data, the server computer 975(a) may determine if the portable consumer background 920 is authentic, by comparing the received fissure data with previously stored fissure data in the database 971. If the portable consumer background is considered to be authentic or is not considered to be authentic, then the server computer 975 (including the computer readable medium 975(a) and the processor 975(b)), may communicate this information to the issuer 980 so that the issuer 980 may determine whether to approve or deny the transaction. The computer readable medium 975(a) may comprise code for receiving a first set of data regarding the unique fissure pattern associated with the portable consumer background, code for comparing the first set of data regarding the unique fissure pattern associated with the portable consumer background with a second set of data regarding the unique fissure pattern associated with the portable consumer background stored in a database, and code for sending an authorization response message based on whether the first set of data regarding the unique fissure pattern associated with the portable consumer background matches the second set of data regarding the unique fissure pattern associated with the portable consumer background stored the database.

The issuer 980 may receive the authorization request message and may determine if the transaction should be approved or denied. After it makes this decision, it may send an authorization response message back to the access device 945 via the server computer 975 in the authentication network 970 informing the requestor 940 and the consumer 910 as to whether or not the transaction is approved.

### Background Characteristics

It should be understood that the present invention as described above may be implemented in the form of control logic using computer software in a modular or integrated manner. Based on the disclosure and teachings provided herein, a person of ordinary skill in the art will know and appreciate other ways and/or processes to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

1. A computer-implemented process of verifying an online financial transaction using video data, the process comprising:
at a device including one or more processors and memory storing one or more programs for execution by the one or more processors:
receiving the video data including a representation of a payment instrument and a background;
identifying one or more payment instrument characteristics from the received video data;
identifying one or more background characteristics from the received video data;
comparing one or more of the identified payment instrument characteristics to corresponding fraudulent payment instrument characteristics to calculate an assessment score;
comparing one or more of the identified background characteristics to corresponding fraudulent background characteristics to further calculate the assessment score;
determining whether the assessment score satisfies a validity threshold; and
providing an authorization indicator in response to the determination.

2. The process of claim 1, further wherein the video data further comprises a front and a back of a payment instrument.

3. The process of claim 1, further comprising reviewing the front of the payment instrument for payment information.

4. The process of claim 1, further comprising reviewing the video data for a reflection in a hologram on the payment instrument.

5. The process of claim 1, further comprising comparing the present video data for the payment instrument to past video data of the payment instrument.

6. The process of claim 1, wherein the video data further comprises background characteristics that are out of the visible light spectrum.

7. The process of claim 3, wherein payment card information comprises at least one of a CVV, card number, an expiration date, an issuing bank, a user name.

8. The process of claim 1, wherein payment card characteristics comprise at least one of defects on card, scratches on the card, discoloration of the card, chips on the card, and extraneous artefacts on the card.

9. The process of claim 1, wherein background characteristics comprises at least one of a surface type, an angle of photo, a lighting measurement of the payment card.

10. The process of claim 1, wherein if the payment card image or background has previously been used in a fraudulent transaction, refusing to authorize the transaction.

11. The process of claim 1, further comprising analyzing the card image and background to determine if the image has been manipulated to indicate fraud.

12. The process of claim 1, wherein the system would store the image which an identification code and a fraud score such that future images may be compared to the image and the past fraud score may indicate a future fraud score.

13. The process of claim 12, wherein the image is analyzed for at least one of counterfeit cards, copied transactions and stolen cards.

14. The process of claim 1, further comprising filtering the image to allow easier optical character recognition of the card information.

15. The process of claim 1, further comprising filtering the image to highlight defects on the card or background.

16. The process of claim 1, further comprising filtering the image to illustrate images that are not visible to the human eye.

17. A computer system for implementing a process of verifying an online financial transaction using video data, comprising:
a computer processor to execute computer executable instructions;
a memory in communication with the processor that stores computer executable instructions;
an input output circuit in communication with the processor;
the computer executable instructions for the process comprising:
receiving the video data including a representation of a payment instrument and a background;
identifying one or more payment instrument characteristics from the received video data;
identifying one or more background characteristics from the received video data;
comparing one or more of the identified payment instrument characteristics to corresponding fraudulent payment instrument characteristics to calculate an assessment score;
comparing one or more of the identified background characteristics to corresponding fraudulent background characteristics to further calculate the assessment score;
determining whether the assessment score satisfies a validity threshold; and
providing an authorization indicator in response to the determination.

18. The computer system of claim 17, wherein payment card characteristics comprise at least one of defects on card, scratches on the card, discoloration of the card, chips on the card, and extraneous artefacts on the card.

19. The computer system of claim 17, further comprising reviewing the video data for a reflection in a hologram on the payment instrument.

20. The computer system of claim 17, wherein the video data further comprises background characteristics that are out of the visible light spectrum.
